(19) United States
(12) Patent Application Publication
(10) Pub. No.: US 2004/0033299 A1
(43) Pub. Date: Feb. 19, 2004

(54) Food and beverage preservative

(76) Inventor: Paul L. Simmons, Pinellas Park, FL (US)

Correspondence Address: Arthur W. Fisher, III, Suite 316, 5553 West Waters Avenue, Tampa, FL, 33634, US

(21) Appl. No.: 10/219,191

(22) Filed: Aug. 14, 2002

(51) Int. Cl. A23B 4/00

(52) U.S. Cl. 426/541

(57) ABSTRACT

A food and beverage preservative formulated to reduce growth of microbial contaminants such as bacteria, mold and spores that cause food and beverage spoilage including a vegetable cellulose fiber, beeswax or bee cream and an antioxidant and a method of manufacturing the food and beverage preservative.

### BACKGROUND OF THE INVENTION

1. Field of the Invention

A food and beverage preservative formulated to reduce growth of microbial contaminants such as bacteria, mold and spores that cause food and beverage spoilage.

2. Description of the Prior Art

Bacteria and other microbial organisms cause food and beverage as well as other products to spoil thereby reducing the shelf life or useful life of such products or goods. Thus, numerous efforts have been made to reduce the deleterious effects of microbial contaminants in organic products and materials.

For example, U.S. Pat. No. 6,103,294 shows a process for producing cellulose pulp and a filtrate of cellulose pulp useful as a preservative for digestible food products. In the emulsification process wax paper, water, preservative potassium sorbate and the surfactant hydroxylated lecithin are heated and blended. The cellulose pulp can be used in various with food products as a preservative or used to rinse fresh fruits and vegetables to increase the time that the fruits or vegetables can be safely stored without refrigeration.

U.S. Pat. No. 5,840,294 and U.S. Pat. No. 5,412,090 disclose a similar method for extending the self life of products such as toothpaste, shampoo, soap, detergent and lotions or creams by adding a hydrous cellulose pulp. The hydrous cellulose pulp is resistant to decomposition and can be produced either with recycled waxed paper or through a process that begins with virgin vegetable constituents and wax.

U.S. Pat. No. 5,840,294 also discloses a cellulose pulp based food preservative including wax paper.

U.S. Pat. No. 6,171,550 B1 shows a similar method for extending the shelf life of products such as toothpaste, shampoo, soap, detergent and lotions or creams by utilizing a water base of about 99% water, 0.68% cellulose and 0.32% emulsified food grade wax. Products produced with this water base will not decompose without chemical preservatives. The hydrous cellulose pulp can be produced either with recycled waxed paper or through a process that begins with virgin vegetable constituents and wax. The filtrate or water base can also be used in the horticultural field to prevent mold on plants and in physiology area to prevent the degradation of cells.

### SUMMARY OF THE INVENTION

The present invention relates to a viscous liquid preservative formulated to reduce growth of microbial contaminants such as bacteria, mold and spores that cause food spoilage.

The viscous liquid preservative of the present invention uses vegetable cellulose fiber, beeswax or bee cream and a water soluble antioxidant. The use of beeswax requires an emulsifier such as soy lecithin. Bee cream is a pre-emulsified beeswax with a melting point of about 120 degrees F.; while, beeswax generally has a melting point of 150 degrees F. or greater.

Since the product contains no toxic chemicals, there are no regulatory limits as to what percentage can be used in a food or beverage. Furthermore, without the problem of toxicity, concentrations can be increased as much as 300% to accommodate the amount of liquid in a particular food product. In addition, since the product is stable at a neutral pH, no flavors or fragrances are needed.

The composition comprises vegetable cellulose fiber, beeswax and soy lecithin or bee cream, and Rosmarinic or water soluble extract from the Labiatae herb family. The balance of the composition comprises water.

To manufacture vegetable cellulose fiber is added to heated water and agitated or mixed to a homogenous solution. Beeswax is then added and agitated or mixed to a homogenous solution. The soy lecithin is added and agitated or mixed to a homogenous solution. Alternatively, bee cream is used without the necessity of the soy lecithin emulsifier. Finally, the Rosmarinic is added. The composition is then filtered and cooled.

The invention accordingly comprises the features of construction, combination of elements, and arrangement of parts that will be exemplified in the construction hereinafter set forth, and the scope of the invention will be indicated in the claims.

### DETAILED DESCRIPTION OF THE PREFERRED EMBODIMENT

The present invention relates to a viscous liquid preservative formulated to reduce growth of microbial contaminants such as bacteria, mold and spores that cause food spoilage.

The viscous liquid preservative comprises a composition of cellulose fiber, bee cream or beeswax and an emulsifier, and an antioxidant.

The cellulose fiber comprises a vegetable cellulose fiber, the emulsifier comprises soy lecithin and antioxidant comprising Rosmarinic as a water soluble Labiatae extract such as Origarum Vulgare and/or Salvia Officinalis.

This particular combination of food grade ingredients permits the composition to be altered or changed dependent of the foodstuff or beverage to be preserved.

The composition comprises from about 0.05 to about 0.15 per cent vegetable cellulose fiber, from about 0.05 to about 0.1 per cent beeswax, from about 0.0005 to about 0.002 per cent soy lecithin and from about 1.0 to about 6.5 per cent Rosmarinic or water soluble Labiatae extract, all by weight. Alternatively, bee cream from about 0.05 to about 1.0 per cent can be substituted for the beeswax and soy lecithin. The balance of the composition comprises water.

The composition preferably comprises about 0.093 per cent vegetable cellulose fiber, about 0.067 per cent beeswax and about 0.001 per cent soy lecithin with the balance water, all by weight. Alternatively, about 0.067 per cent bee cream may be substituted for the beeswax and soy lecithin.

The Rosmarinic or water soluble Labiatae extract probably comprises about 3.0 per cent. The vegetable cellulose fiber is preferably less than about 40 microns in size.

The resulting viscous liquid preservative has a conductivity from about 6.5 micromos to about 10.5 micromos; preferably about 8.5 micromos. The dissolved oxygen content is less than about 18 parts per million; preferably about 16 parts per million.

To manufacture the viscous liquid preservative using beeswax, the water is heated to between about 160 and 180 degrees F. and preferably at least 165 degrees F. The vegetable cellulose fiber is added to the heated water and agitated or mixed to a homogenous solution that generally is accomplished in about 5 minutes. The beeswax is then added and agitated or mixed to a homogenous solution that generally takes about 2 minutes. The soy lecithin is added and agitated or mixed to a homogenous solution that generally takes about 5 minutes. Finally, the Rosmarinic is added. The composition is then pumped through filters at a pressure of less than about 30 psi and then cooled to at least about 90 degrees F.

To manufacture the viscous liquid preservative using bee cream, the water is heated to between about 120 and 165 degrees F. and preferably about 140 degrees F. The vegetable cellulose fiber is added to the heated water and agitated or mixed to a homogenous solution that generally is accomplished in about 5 minutes. The bee cream is then added and agitated or mixed to a homogenous solution that generally takes about 2 minutes. The Rosmarinic or water soluble Labiatae extract is added and agitated or mixed to a homogenous solution that generally takes about 5 minutes. The composition is then cooled to at least about 90 degrees F.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

What is claimed is:

1. A food and beverage preservative formulated to reduce growth of microbial contaminants such as bacteria, mold and spores that cause food and beverage spoilage including a cellulose fiber and an antioxidant.

2. The food and beverage preservative of claim 1 wherein said cellulose fiber comprises vegetable cellulose fiber.

3. The food and beverage preservative of claim 2 wherein said antioxidant comprises a water soluble Labiatae extract.

4. The food and beverage preservative of claim 3 further comprising bee cream.

5. The food and beverage preservative of claim 2 further comprising bee cream.

6. The food and beverage preservative of claim 3 further comprising beeswax and an emulsifier.

7. The food and beverage preservative of claim 6 wherein said emulsifier is soy lecithin.

8. The food and beverage preservative of claim 2 further comprising beeswax and an emulsifier.

9. The food and beverage preservative of claim 8 wherein said emulsifier comprises soy lecithin.

10. The food and beverage preservative of claim 1 further comprising water.

11. A food and beverage preservative formulated to reduce growth of microbial contaminants such as bacteria, mold and spores that cause food and beverage spoilage comprising from about 0.05 to about 0.15 per cent vegetable cellulose fiber and from about 1.0 to about 6.5 per cent antioxidant.

12. The food and beverage preservative of claim 11 wherein said antioxidant comprises a water soluble Labiatae extract.

13. The food and beverage preservative of claim 11 wherein said antioxidant comprises Rosmarinic.

14. The food and beverage preservative of claim 13 further comprising from about 0.05 to about 1.0 percent bee cream by weight.

15. The food and beverage preservative of claim 13 further comprising from about 0.05 to about 0.1 per cent beeswax and from about 0.0005 to about 0.002 per cent soy lecithin, all by weight.

16. The food and beverage preservative of claim 11 further comprising from about 0.05 to about 1.0 per cent bee cream by weight.

17. The food and beverage preservative of claim 11 further comprising from about 0.05 to about 0.1 per cent beeswax and from about 0.0005 to about 0.002 per cent soy lecithin, all by weight.

18. The food and beverage preservative of claim 11 wherein the conductivity of said composition is at least about 6.5 micromos.

19. The food and beverage preservative of claim 11 wherein the conductivity of said composition is from about 6.5 micromos to about 10.5 micromos.

20. The food and beverage preservative of claim 11 wherein the conductivity of said composition is about 8.5 micromos.

21. A food and beverage preservative formulated to reduce growth of microbial contaminants such as bacteria, mold and spores that cause food and beverage spoilage, comprising about 0.093 per cent vegetable cellulose fiber, about 3 per cent Rosmarinic, about 0.067 per cent beeswax and about 0.001 soy lecithin with the balance water, all by weight.

22. The food and beverage preservative of claim 21 wherein the conductivity of said composition is about 8.5 micromos.

23. A food and beverage preservative formulated to reduce growth of microbial contaminants such as bacteria, mold and spores that cause food and beverage spoilage comprising about 0.093 per cent vegetable cellulose fiber, about 3 per cent Rosmarinic and about 0.067 per cent bee cream with the balance water, all by weight.

24. The food and beverage preservative of claim 23 wherein the conductivity of said composition is about 8.5 micromos.

25. A method of manufacturing a food and beverage preservative comprising the following steps: (1) heating water to between about 160 to about 180 degrees F.; (2) adding vegetable cellulose fiber and mixing to a substantially homogenous solution and (3) adding an antioxidant and mixing to a substantially homogenous solution.

26. The method of manufacturing a food and beverage preservative of claim 25 further including the additional step of cooling said composition to at least about 90 degrees F.

27. The method of manufacturing a food and beverage preservative of claim 25 wherein said the antioxidant comprises Rosmarinic.

28. The method of manufacturing a food and beverage preservative of claim 27 further comprising beeswax.

29. The method of manufacturing a food and beverage preservative of claim 28 further comprising an emulsifier.

30. The method of manufacturing a food and beverage preservative of claim 29 wherein said emulsifier comprises soy lecithin.

31. The method of manufacturing a food and beverage preservative of claim 30 wherein said composition comprises from about 0.05 to about 0.15 per cent vegetable cellulose fiber, from about 1.0 to about 6.5 per cent Rosmarinic, from about 0.05 to about 0.1 per cent per cent beeswax and from about 0.0005 to about 0.002 per cent soy lecithin with the balance water, all by weight.

32. The method of manufacturing a food and beverage preservative of claim 31 wherein said composition comprises about 0.093 per cent vegetable cellulose fiber; about 3.0 per cent Rosmarinic; about 0.067 per cent beeswax and about 0.001 per cent soy lecithin with the balance water, all by weight.

33. A method of manufacturing a food and beverage preservative comprising the following steps: (1) heating water to between about 120 to about 165 degrees F.; (2) adding vegetable cellulose fiber and mixing to a substantially homogenous solution and (3) adding bee cream and mixing to a substantially homogeneous solution; (4) adding an antioxidant and mixing to a substantially homogenous solution.

34. The method of manufacturing a food and beverage preservative of claim 33 further including the additional step of cooling said composition to at least about 90 degrees F.

35. The method of manufacturing a food and beverage preservative of claim 33 wherein said antioxidant comprises Rosmarinic.

36. The method of manufacturing a food and beverage preservative of claim 35 wherein said composition comprises from about 0.05 to about 0.15 per cent vegetable cellulose fiber, from about 1.0 to about 6.5 per cent Rosmarinic and, from about 0.05 to about 1.0 per cent bee cream with the balance water, all by weight.

37. The method of manufacturing a food and beverage preservative of claim 31 wherein said composition comprises about 0.093 per cent vegetable cellulose fiber; about 3.0 per cent Rosmarinic; about 0.067 per cent beeswax and about 0.001 or less per cent soy lecithin with the balance water, all by weight.

38. The method of manufacturing a food and beverage preservative of claim 33 wherein said antioxidant comprises a water soluble Labiatae extract.
